(19) United States
(12) Patent Application Publication
(10) Pub. No.: US 2018/0202514 A1
(43) Pub. Date: Jul. 19, 2018

(54) TORSIONAL VIBRATION DAMPER FOR HYDRODYNAMIC TORQUE CONVERTER, AND TORQUE CONVERTER INCLUDING THE SAME

(71) Applicant: VALEO EMBRAYAGES, Amiens Cedex 2 (FR)

(72) Inventor: Zane YANG, Troy, MI (US)

(21) Appl. No.: 15/405,812

(22) Filed: Jan. 13, 2017

(51) Int. Cl. F16F 15/121; F16H 41/24; F16H 45/02

(52) U.S. Cl. CPC F16F 15/1215; F16H 2045/0221; F16H 45/02; F16H 41/24

(57) ABSTRACT

A torsional vibration damper is provided that includes a drive-side transmission element, a driven-side transmission element, and an energy-storage member rotatable relative to the drive-side transmission element and rotationally coupled to the driven-side transmission element. The energy-storage member includes radially inner elastic blades, and radially outer elastic blades positioned radially outward relative to the radially inner elastic blades. The drive-side transmission element is operatively associated with the energy-storage member to cause the radially inner elastic blades and the radially outer elastic blades to be displaced radially and elastically in response to relative rotation between the drive-side and driven-side transmission elements about a rotational axis of the torsional vibration damper. A hydrodynamic torque converter including the torsional vibration damper is also provided.

### BACKGROUND OF THE INVENTION

### 1. Field of the Invention

The present invention generally relates to torsional vibration dampers suitable for use in hydrodynamic torque converters, hydrodynamic torque converters containing torsional vibration dampers, and methods of making and using torsional vibration dampers and hydrodynamic torque converters.

### 2. Background of the Invention

Hydrodynamic torque converters are installed in motor vehicles, particularly those including internal combustion engines, to control the transmission of torque from a prime mover drive shaft, such as a crankshaft of the internal combustion engine, to a rotating driven load, such as a transmission input shaft. Often, hydrodynamic torque converters are provided with torsional vibration dampers to attenuate torsional vibrations transmitted by the engine. Torsional vibration dampers typically include a drive-side transmission element rotationally coupled to (and thus non-rotatable relative to) the prime mover drive shaft, a driven-side transmission element rotationally coupled to the transmission input shaft, and a plurality of energy-storage dampers. Typically, the energy-storage dampers are circumferentially extending coil springs interposed between the drive-side transmission element and the driven-side transmission element. The elastic nature of coil springs absorbs engine-generated torsional vibration while allowing for rotational movement of the driven-side transmission element relative to the drive-side transmission element.

Conventional torsional vibration dampers sometimes have drawbacks, including a relatively large number of moving parts, labor-intensive assembly, wear on the coil springs, and friction between the coils and surrounding components. Another drawback is that the stiffness characteristics (stiffness versus rotational angles) cannot be designed to meet exact vibration-suppression requirements.

### BRIEF SUMMARY OF THE INVENTION

According to a first aspect of the invention, a torsional vibration damper is provided that includes a drive-side transmission element, a driven-side transmission element, and an energy-storage member rotatable relative to the drive-side transmission element and rotationally coupled to the driven-side transmission element. The energy-storage member includes radially inner elastic blades, and radially outer elastic blades positioned radially outward relative to the radially inner elastic blades. The drive-side transmission element is operatively associated with the energy-storage member to cause the radially inner elastic blades and the radially outer elastic blades to be displaced radially and elastically in response to relative rotation between the drive-side and driven-side transmission elements about a rotational axis of the torsional vibration damper.

A second aspect of the present invention provides a hydrodynamic torque converter including a casing, an impeller rotationally coupled to the casing, a turbine hydrodynamically rotationally drivable by the impeller, and a torsional vibration damper rotationally coupled to the casing, the turbine, or both the casing and the turbine. The torsional vibration damper includes a drive-side transmission element, a driven-side transmission element, and an energy-storage member. The energy-storage member is rotatable relative to the drive-side transmission element and rotationally coupled to the driven-side transmission element. The energy-storage member includes radially inner elastic blades, and radially outer elastic blades positioned radially outward relative to the radially inner elastic blades. The drive-side transmission element is operatively associated with the energy-storage member to cause the radially inner elastic blades and the radially outer elastic blades to be displaced radially and elastically in response to relative rotation between the drive-side and driven-side transmission elements about a rotational axis of the torsional vibration damper.

Other aspects of the invention, including apparatus, devices, systems, converters, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is a half-view in axial section of a hydrodynamic torque converter in accordance with an exemplary embodiment of the present invention;

FIG. 2 is a half-view of the hydrodynamic torque converter of FIG. 1 taken along a different axial section than FIG. 1;

FIG. 3 is a perspective side view of a torsional vibration damper of the hydrodynamic torque converter of FIGS. 1 and 2;

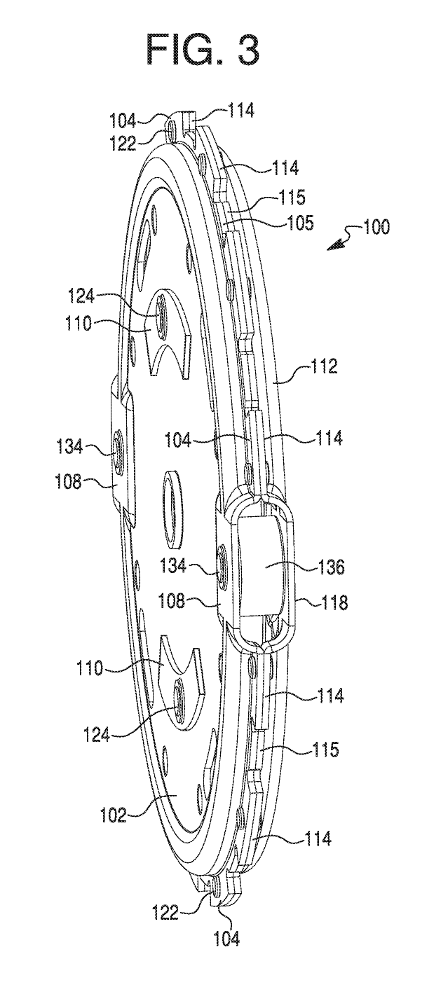

FIG. 4 is a partially disassembled perspective front view of the torsional vibration damper of FIG. 3;

FIG. 5 is a simplified front elevational view of the torsional vibration damper of FIGS. 3 and 4;

FIG. 6 is a perspective view of an energy-storage member of the torsional vibration damper of FIGS. 3 through 5; and

FIG. 7 is a front elevational view of the energy-storage member of FIG. 6 showing the energy-storage member in deformed and non-deformed states.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the written description.

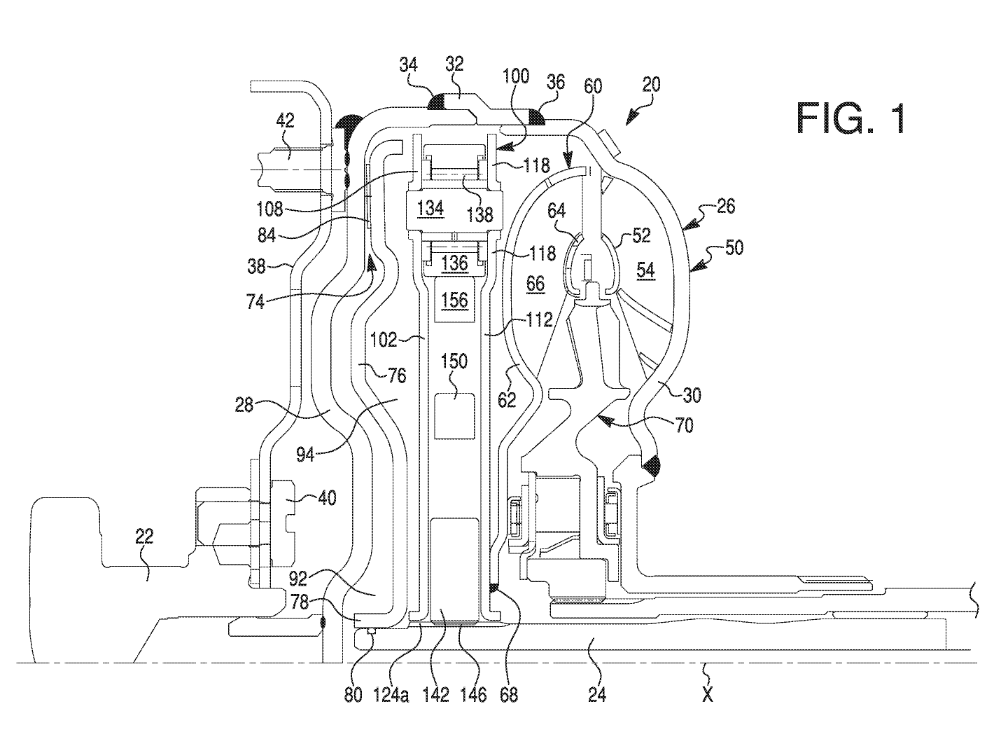

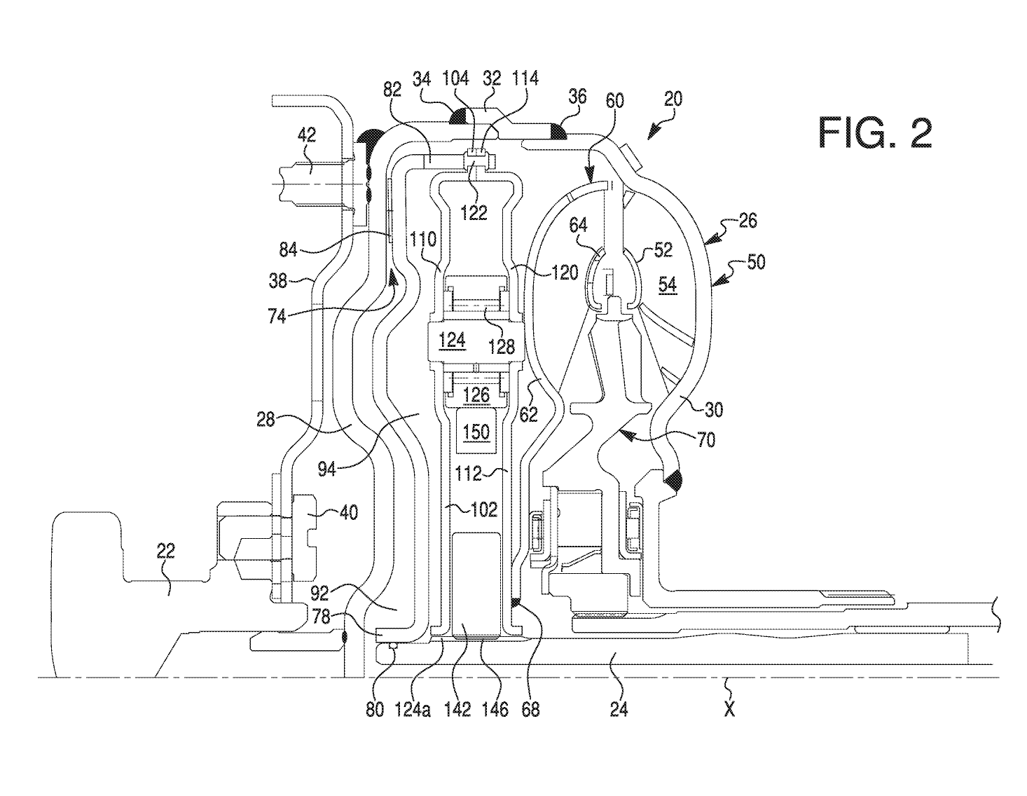

An exemplary embodiment of a hydrodynamic torque converter is generally represented in FIGS. 1 and 2 by reference numeral 20. The hydrodynamic torque converter 20 is configured to couple a driving shaft 22 of a prime mover (not shown), such as an internal combustion engine, and a driven shaft 24, such as an input shaft of an automatic transmission (not shown).

The hydrodynamic torque converter 20 includes a sealed casing 26 that encloses a chamber filled with a fluid, such as oil or hydraulic fluid. As is known in the art, the chamber of the sealed casing 26 may be divided into smaller compartments, such as compartments 92 and 94, for operational control over the hydrodynamic torque converter 20, as discussed further below. The sealed casing 26 is rotatable about a longitudinal rotational axis X. The terms “axially,” “radially,” and “circumferentially” are with respect to orientations parallel to, perpendicular to, and circularly around the rotational axis X, respectively, unless otherwise indicated.

The sealed casing 26 includes a first shell (or casing shell) 28 and a second shell (or impeller shell) 30 disposed coaxially with and axially opposite to the first shell 28. A third shell 32 is interposed between and interconnects the first and second shells 28 and 30. Weld 34 fixedly connects and seals the first and third shells 28 and 32 to one another in non-movable relative relationship. Similarly, weld 36 fixedly connects and seals the second and third shells 30 and 32 to one another in non-movable relative relationship. Alternatively, the third shell 32 may be excluded, and the first and second shells 28 and 30 may be directly fixed and sealed together using a weld similar to weld 34 or 36.

Bolts 40 rotationally connect the driving shaft 22 to a radially inner end portion of a flex plate 38 so that the driving shaft 22 is rotationally coupled to and non-rotatable relative to) the flex plate 38. Studs 42 similarly rotationally connect a radially outer end portion of the flex plate 38 to the first shell 28, thereby rotationally interconnecting the driving shaft 22 to the first shell 28 (as well as the second and third shells 30 and 32) so as to be non-rotatable relative to one another. In this manner, the casing 26 rotates at the same speed as the engine output.

The hydrodynamic torque converter 20 includes an impeller (sometimes referred to as the pump or impeller wheel) 50, a turbine (sometimes referred to as the turbine wheel) 60, and a stator (sometimes referred to as the reactor) 70 interposed axially between radially inner areas of the impeller 50 and the turbine 60. The impeller 50, the turbine 60, and the stator 70 are coaxially aligned with one another and the rotational axis X. The impeller 50, the turbine 60, and the stator 70 collectively form a torus. The impeller 50 and the turbine 60 may be operatively fluidly coupled to and uncoupled from one another, as known in the art.

The semi-toroidal (or concave) portion of the second shell 30 of the casing 26 also serves as an impeller shell of the impeller 50. The impeller 50 further includes an annular impeller core ring 52 spaced from the impeller shell/second shell 30. Impeller blades 54 are fixedly attached, such as by brazing, to the impeller shell 30 and the impeller core ring 52. The impeller 50 is non-rotatable relative to the driving shaft 22 and interconnected to the driving shaft 22 via a torque path that travels through the rivets 40, the flex plate 38, the studs 42, and the casing 26. The impeller core ring 52 and the impeller blades 54 may be formed, for example, by stamping metal (e.g., steel) blanks, as is known in the art.

The turbine 60 includes an annular turbine shell 62 having a semi-toroidal portion (unnumbered) facing the semi-toroidal portion of the second shell 30. The turbine 60 further includes an annular turbine core ring 64. A plurality of turbine blades 66 are fixedly attached, such as by brazing, to the turbine shell 62 and the turbine core ring 64. The turbine shell 62, the turbine core ring 64, and the turbine blades 66 may be formed, for example, using conventional processes such as stamping steel blanks.

The hydrodynamic torque converter 20 further includes a lock-up clutch generally designated by reference numeral 74. The lock-up clutch 74 includes an annular locking piston 76 having a radially inner flanged end 78 slidingly mounted on the driven shaft 24. A seal 80, such as an o-ring, is provided at the interface of the flanged end 78 of the locking piston 76 and the outer surface of the driven shaft 24. As best shown in FIG. 2, a radially outer end of the locking piston 76 includes a plurality of axially extending tabs (or lugs) 82 circumferentially spaced from one another. The tabs 82 are discussed in greater detail below. An annular friction liner 84 is adhered or otherwise attached to a radially extending surface of the locking piston 76 so as to face an inner surface area of the casing 26, in particular an inner surface area of the first shell 28 in FIGS. 1 and 2. When the lock-up clutch 74 is in locking mode, the annular friction liner 84 frictionally engages the inner surface of the first shell 28 so that the first shell 28 is rotationally locked to the locking piston 76, i.e., the first shell 28 is non-rotatable relative to the locking piston 76. When the lock-up clutch 74 is out of locking mode, the annular friction liner 84 does not frictionally engage the inner surface of the first shell 28, so that the first shell 28 is rotatable relative to the locking piston 76. Generally, the lock-up clutch 74 mechanically locks the engine to the transmission when their speeds are substantially the same, thereby preventing efficiency losses cause by slip phenomena between the impeller 50 and the turbine 60.

The locking piston 76 is axially moveable parallel to the rotational axis X toward and away from the facing surface of the first shell 28 to respectively lock and unlock the locking piston 76 against the facing surface of the first shell 28. Axial movement of the locking piston 76 along the driven shaft 24 is controlled by varying the respective fluid pressures in the compartments 92 and 94 of the casing 26 on opposite sides of the locking piston 76.

The hydrodynamic torque converter 20 further includes a torsional vibration damper 100 configured to absorb engine-generated torsional vibration while allowing for rotational movement of a driven-side transmission element relative to a drive-side transmission element. In a preferred embodiment, the torsional vibration damper 100 does not contain any (i.e., is free of) circumferentially extending springs, in particular coil springs.

The torsional vibration damper 100 is interposed axially between the turbine shell 62 and the locking piston 76. The torsional vibration damper 100 is annular and rotatable about the rotational axis X.

The drive-side input element of the torsional vibration damper 100 is embodied as a first (piston-side) retainer plate 102 and a second (turbine-side) retainer plate 112 that are parallel to one another. The first and second retainer plates 102 and 112 may be substantial mirror images of one another. The outer periphery of the first retainer plate 102 includes first peripheral flanges 104 that extend radially outwardly and first notches 105 circumferentially spacing the peripheral flanges 104 from one another. The first peripheral flanges 104 each include at least one first fastener hole (unnumbered). The first retainer plate 102 further includes two first peripheral mounting indentations 108 that are diametrically opposite to one another, and two first inner mounting indentations 110 that are diametrically opposite to one another and angularly offset from the first peripheral mounting indentations 108. Similarly, the second retainer plate 112 includes second peripheral flanges 114, second notches 115, second fastener holes 116, second peripheral mounting indentations 118, and second inner mounting indentations 120 configured and arranged in the same manner described above with respect to their first counterparts 104, 106, 108, and 110, respectively.

The first and second peripheral flanges 104 and 114 abut one another in a manner that aligns the fastener holes (unnumbered) of the first peripheral flanges 104 and the fastener holes 116 of the second peripheral flanges 114 with one another. Each of the aligned sets of fastener holes receives a respective fastener 122, such as a rivet, bolt, etc. The fasteners 122 secure the first and second retainer plates 102 and 112 together in non-rotatable relationship relative to one another so that the first and second retainer plates 102 and 112 are rotationally coupled to one another. Similarly, the first and second peripheral mounting indentations 108 and 118 align with and face one another to define peripheral mounting pockets therebetween, and the first and second inner mounting indentations 110 and 120 align with and face one another to define radially inner mounting pockets therebetween.

Two radially inner shafts 124 are mounted in the radially inner mounting pockets defined by the first and second inner mounting indentations 110 and 120. The two radially inner shafts 124 are mounted at diametrically opposite positions. The radially inner shafts 124 extend axially between the first and second inner mounting indentations 110 and 120, and have central axes that are parallel to the rotational axis X. Support pins (not shown) may be provided to secure the radially inner shafts 124 to the retainer plates 102 and 112. Each of the radially inner shafts 124 has a respective radially inner roller body 126 rotatably mounted thereon. Radially inner roller bearings 128, such as needle bearings, facilitate rotation of the radially inner roller bodies 126 about the central axes of the radially inner shafts 124.

Similarly, two radially outer (or peripheral) shafts 134 are mounted in the peripheral mounting pockets defined by the first and second peripheral mounting indentations 108 and 118. The two radially outer shafts 134 are mounted at diametrically opposite positions, and are angularly offset from the two radially inner shafts 124. The radially outer shafts 134 extend axially between the first and second peripheral mounting indentations 108 and 118, and have central axes that are parallel to the rotational axis X. Support pins (not shown) may be provided to secure the radially outer shafts 134 to the retainer plates 102 and 112. Each of the radially outer shafts 134 has a respective radially outer (or peripheral) roller body 136 rotatably mounted thereon. Radially outer (or peripheral) roller bearings 138, such as needle bearings, facilitate rotation of the radially outer roller bodies 136 about the central axes of the radially outer shafts 134.

The radially inner roller bodies 126 and the radially outer roller bodies 136, along with the first and second retainer plates 102 and 112, form the drive-side transmission element of the torsional vibration damper 100. It should be understood that various modifications and alternations may be made to the exemplary embodiment. For example, the torsional vibration damper 100 may include only a single retainer plate 102 or 112 on which the radially inner roller bodies 126 and the radially outer roller bodies 136 are mounted. As another example, the roller bodies 126 and 136 may be replaced with non-roller bodies, for example bodies made of a low friction material.

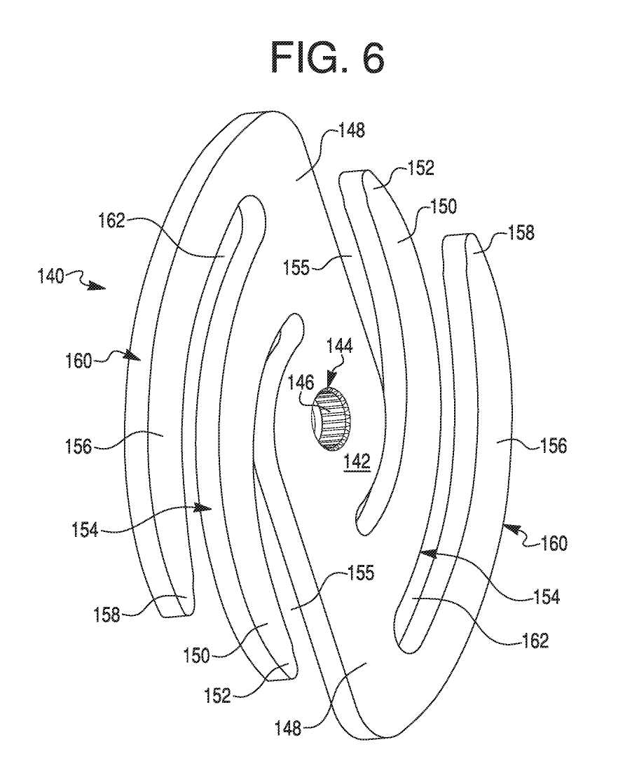

The torsional vibration damper 100 also includes a radially elastic, energy-storage member 140, as best shown in FIG. 6, that is rotatable about the rotational axis X relative to the first and second retainer plates 102 and 112 (and the roller bodies 126 and 136). The energy-storage member 140 includes an annular output hub 142 coaxial with the rotational axis X. The annular output hub 142 includes a central mounting hole 144 defined by a radially inner cylindrical surface of the energy-storage member 140. The central mounting hole 144 includes axial splines 146 configured to directly engage complementary axial splines 24a of the driven shaft 24. The splined engagement of axial splines 24a and 146 allows the energy-storage member 140, and in particular the annular output hub 142 of the energy-storage member 140, to move axially relative to the driven shaft 24.

The energy-storage member 140 includes radial arms 148 extending radially outward from diametrically opposite positions of the output hub 142. Radially inner elastic blades (also referred to as leaves) 150 extend from the radial arms 148 to terminate at distal ends (or tips) 152. Each of the distal ends 152 is circumferentially spaced from the opposite radial arm 148. The radially inner elastic blades 150 have radially outer surfaces 154 that define inner raceways having a generally convex shape. The radially inner elastic blades 150 are spaced apart from the radially outer surface of the output hub 142 by a radially inner gap 155.

The energy-storage member 140 further includes radially outer elastic blades (also referred to as leaves) 156 extending from the radial arms 148 at positions radially outward relative to the radially inner elastic blades 150. Each of the radially outer elastic blades 156 terminates at a respective distal end (or tip) 158 that is circumferentially spaced from the opposite radial arm 148. The radially outer elastic blades 156 have radially outer surfaces 160 that define outer raceways having a generally convex shape. The radially outer elastic blades 156 are spaced from the inner raceways 154 of the radially inner elastic blades 150 by a radially outer gap 162.

Each of the elastic blades 150 and 156 is elastically deformable in a radially inward direction. Preferably, the radially inner elastic blades 150 and/or the radially outer elastic blades 156 extend in a range of 90 to less than 180 degrees about the output hub 142.

The energy-storage member 140 preferably is a one-piece integral body, and preferably is made of elastic high strength material with high energy storage capability. The energy-storage member 140 may have a uniform thickness. The annular output hub 142, the opposite radial arms 148, and the radially inner and outer elastic blades 150 and 156 preferably are made integrally with one other as a one-piece integral body. For example, the energy-storage member 140 may be made of a metal such as steel by stamping and optionally heat treatment. Alternatively, the energy-storage member 140 may be made of multiple pieces connected together. For example, the output hub 142 may be formed separately from and connected (e.g., riveted or otherwise fastened or welded) to the radial arms 148.

The radially inner and radially outer roller bodies 126 and 136 engage the radially inner raceways 154 and the radially outer raceways 160, respectively, to radially support the energy-storage member 140. The radially inner roller bodies 126 are in rolling contact with the respective radially inner raceways 154, and the radially outer roller bodies 136 are in rolling contact with the respective radially outer raceways 160. As described in greater detail below, the radially inner and radially outer elastic blades 150 and 156 bend elastically in the radial direction upon rotation of the energy-storage member 140 relative to the roller bodies 126 and 136.

Returning to FIG. 2, the axially extending tabs 82 of the locking piston 76 engage notches 105 and 115 to rotationally couple the locking piston 76 to the first and second retainer plates 102 and 112 (so that the locking piston 76 is non-rotatable relative to the retainer plates 102 and 112). At the same time, engagement of the tabs 82 and notches 105 and 115 allows axial motion of the locking piston 76 with respect to the retainer plates 102 and 112, whereby the locking piston 76 is not prevented from moving axially into and out of lock-up mode.

The second retainer plate 112 is rotationally coupled to and axially fixed to the turbine shell 62 by weld 68 at a radially inner end of the turbine shell 62. Alternatively, mechanical fasteners may be used in lieu of the weld 68, or the turbine shell 62 may be integral with the second retainer plate 112.

The axial motion of the locking piston 76 is controlled by controlling the fluid pressures in the compartments 92 and 94 on the opposite axial sides of the locking piston 76. Increasing the fluid pressure in the compartment 92 relative to the compartment 94 moves the locking piston 76 to the right in FIGS. 1 and 2, placing the lock-up clutch 74 out of lock-up mode. Increasing the fluid pressure in the compartment 94 relative to the compartment 92 moves locking piston 76 to the left in FIGS. 1 and 2, placing the lock-up clutch 74 into lock-up mode.

Activation of the lock-up clutch 74 allows torque to be transmitted from the driving shaft 22 of the primary mover to the driven shaft 24 of the transmission without involving hydrokinetic coupling of the impeller 50, the turbine 60, and the stator 70. In lockup mode, torque is transmitted from the driving shaft 22 via the fasteners 40 to the flex plate 38, via the studs 42 to the casing 26, via frictional lining 84 to the locking piston 76, and via tabs 82 to the retainer plates 102 and 112. As discussed above, the first and second retainer plates 102 and 112 are non-rotatably connected to one another by the rivets 122, yet are rotatable relative to the energy-storage member 140. Torque is transferred from the roller bodies 126 and 136 mounted on the retainer plates 102 and 112 to the energy-storage member 140, as discussed further below, and to the output hub 142 of the energy-storage member 140. The output hub 142 is splined directly to the driven shaft 24 via intermeshing splines 24a and 146.

Disengagement of the lock-up clutch 74 allows torque to be transmitted from the driving shaft 22 of the primary mover to the driven shaft 24 of the transmission through the hydrokinetic coupling of the impeller 50, the turbine 60, and the stator 70. When the lock-up clutch 74 is disengaged, torque is transmitted from the driving shaft 22 via the fasteners 40 to the flex plate 38, via the studs 42 to the casing 26, to the impeller 50, hydrodynamically to the turbine 60, and via weld 68 to the second retainer plate 112. The first and second retainer plates 102 and 112 are non-rotatably connected to one another by the rivets 122, yet are rotatable relative to the energy-storage member 140. Torque is transferred from the roller bodies 126 and 136 mounted on the retainer plates 102 and 112 to the energy-storage member 140, as discussed further below, and to the output hub 142 of the energy-storage member 140. The output hub 142 is splined directly to the driven shaft 24 via intermeshing splines 24a and 146.

The radially inner and radially outer shafts 124 and 134 mount the radially inner and radially outer roller bodies 126 and 136, respectively, to the first and second retainer plates 102 and 112. The shafts 124 and 134 are rotationally coupled to (and hence non-rotatable about the rotational axis X relative to) the retainer plates 102 and 112. The radially inner and radially outer roller bodies 126 and 136 are, however, rotatable about the axes of their associated radially inner and radially outer shafts 124 and 134 due to the associated radially inner and radially outer roller bearings 128 and 138.

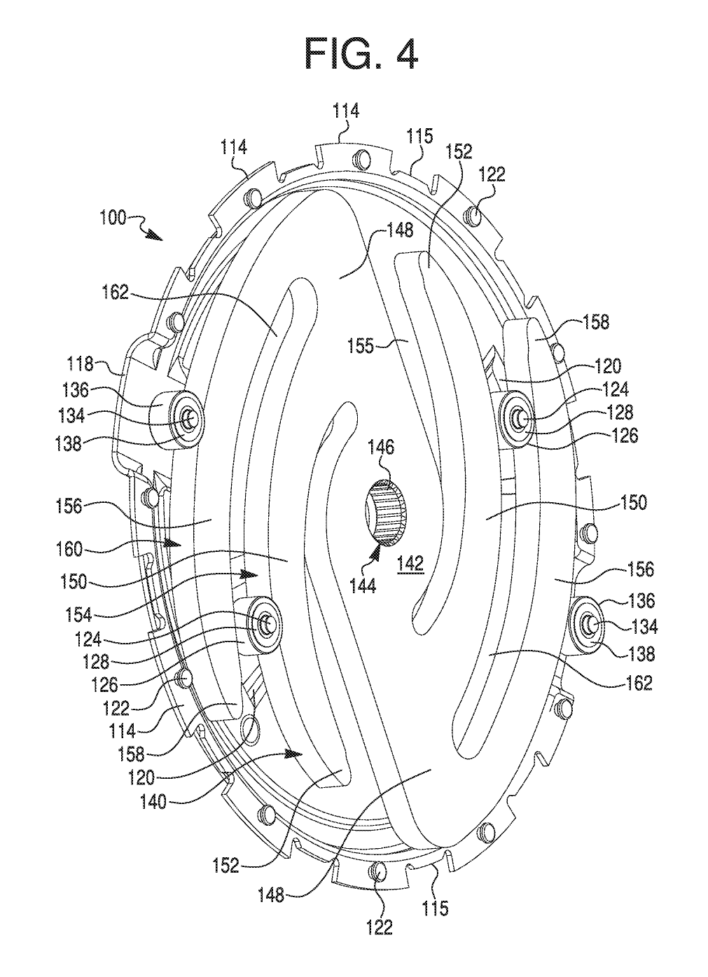

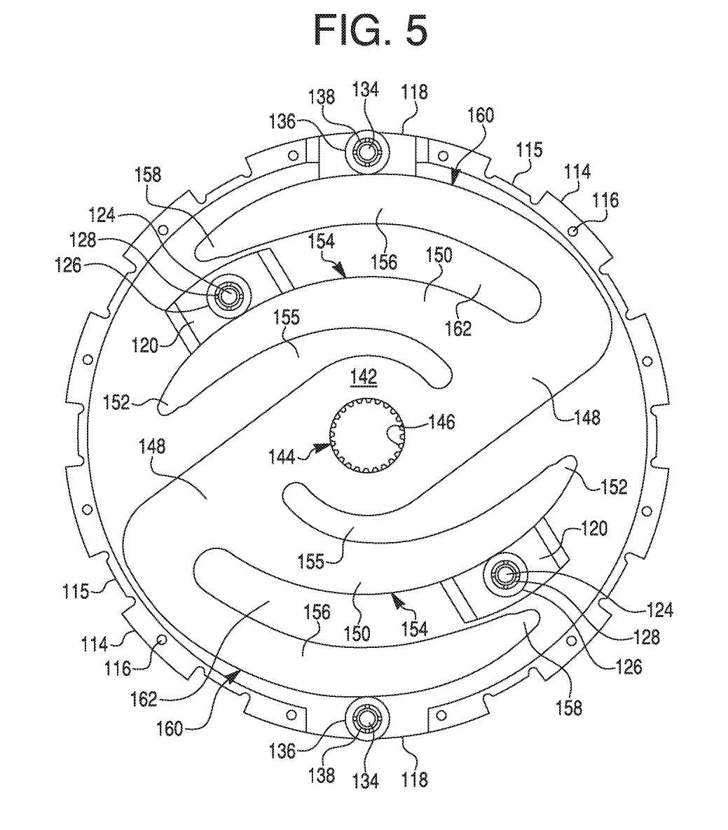

FIGS. 4 and 5 show the torsional vibration damper 100 in a rest position. The rest position is the relative position between the drive-side transmission member, i.e., the retainer plates 102 and 112 and radially inner and radially outer roller bodies 126 and 136, and the driven-side transmission member, i.e., the output hub 142, wherein no torque is transmitted to the output hub 142.

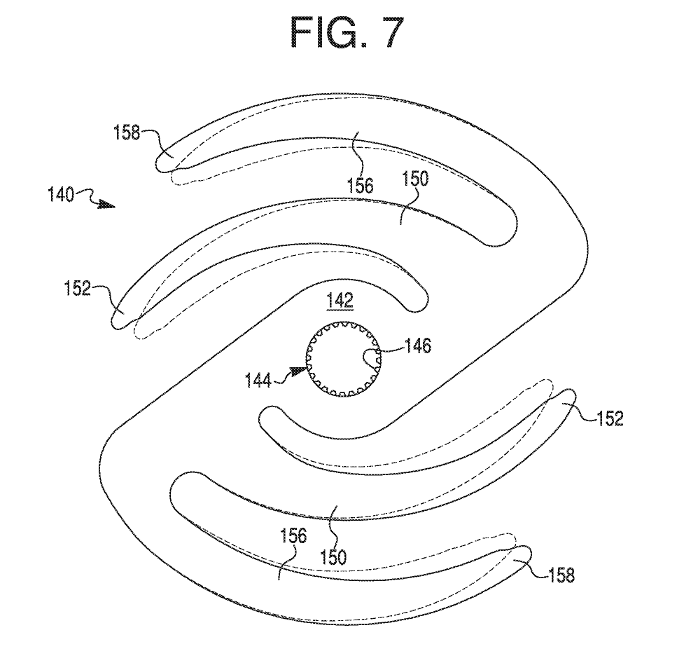

In the rest position, the radially inner and radially outer roller bodies 126 and 136 preferably pre-load their associated radially inner and radially outer elastic blades 150 and 156 of the energy-storage member 140 to flex the respective distal ends 152 and 158 toward the rotational axis X. The pre-loading of the energy-storage member 140 is shown in FIG. 7, in which the solid lines represent the energy-storage member 140 in a non-deformed state, and the broken lines represent the energy storage member 140 in a deformed state, in which the distal ends 152 and 158 are radially inward compared to the non-deformed state.

The elastic property of the elastic blades 150 and 156 exerts a recovery force (or contact or reaction force) substantially radially outward to maintain the energy-storage member 140 in contact with the associated roller bodies 126 and 136. The force between the blades 150 and 156 and the associated roller bodies 126 and 136 is directed to travel through the rotational axis X at the rest position. The rest position is characterized by a minimum recovery force collectively exerted by the elastic blades 150 and 156 on the associated roller bodies 126 and 136. Clockwise or counterclockwise movement (about the rotational axis X) of the energy-storage member 140 relative to the roller bodies 126 and 136 from the rest position causes the roller bodies 126 and 136 to displace the associated elastic blade distal ends 152 and 158 farther radially inward, and thereby increases the recovery force exerted by the elastic blades 150 and 156.

Variation of the operating torque between the casing 26 and the output hub 142 of the torsional vibration damper 100 causes the energy-storage member 140 to rotate about the rotational axis X away from the relative rest position. In particular, the roller bodies 126 and 136 roll along the associated curved radially inner and outer raceways 154 and 160, respectively, in response to relative rotation between the casing 26 and the output hub 142. The roller bodies 126 and 136 rotate about their associated shafts 124 and 134 as the roller bodies 126 and 136 roll along the associated raceways 154 and 160. The raceways 154 and 160 have profiles configured so that as the roller bodies 126 and 136 move along the raceways 154 and 160, respectively, the roller bodies 126 and 136 exert a greater radially inward bending force on the respective elastic blades 150 and 156 and the free distal ends 152 and 158 move towards the rotational axis X. The inward bending force and deflection of the elastic blades 150 and 156 continue to increase as the roller bodies 126 and 136 proceed farther along the raceways 154 and 160.

When torque decreases, the recovery force of the elastic blades 150 and 156 rotates the energy-storage member 140 in an opposite direction back towards its rest position. The energy-storage member 140 returns to the rest position when the torque equals zero. Notably, as the energy-storage member 140 rotates back towards its rest position, movement of the roller bodies 126 and 136 along the raceways 154 and 160 causes the roller bodies 126 and 136 to rotate about their associated shafts 124 and 134.

According to the exemplary embodiment, the angular displacement (rotation) of the retainer plates 102 and 112 relative to the output hut 142 of the energy absorption body 140 is greater than 20°, preferably greater than 40°, about the rotational axis X. The elastic blades 150 are symmetrical to each other about the rotational axis X, and the elastic blades 156 are symmetrical to each other about the rotational axis X.

The provision of multiple sets of elastic blades 150 and 156 radially offset from one another increases torque capacity in the course of damping without necessitating dedication of additional axial space. In contrast, a damper having only one set of elastic blades might require, for example, an increase in the thickness of the elastic blades, and hence a corresponding increase in the overall size of the torsional vibration damper, in order to increase torque capacity.

The profiles of the radially inner raceways 154 of the radially inner elastic blades 150 are not necessarily the same as the profiles of the radially outer raceways 160 of the radially outer elastic blades 156. Variation of the raceway profiles of the elastic blades 150 and 156 provides a wide array of design options in achieving desirable load-versus-angle characteristics.

Other variations to the exemplary embodiment described above are also possible. For example, the energy-storage member 140 may include more than two radially inner elastic blades 150 and/or more than two radially outer elastic blades 156. The number of radially inner elastic blades 150 and the number of radially outer blades 156 are not necessarily equal to one another. The energy-storage member 140 may include three or more sets of elastic blades, e.g., an additional set of intermediate elastic blades radially interposed between the radially inner elastic blades 150 and the radially outer elastic blades 156.

An exemplary method for assembling the hydrodynamic torque converter 20 is described below. This exemplary method is not the exclusive method for assembling the turbine assembly described herein.

An exemplary method for assembling the hydrodynamic torque converter 20 involves assembling the impeller 50, the turbine 60, and the stator 70 to form the torus. The impeller 50, the turbine 60, and the stator 70 may be formed from stamped steel blanks or injection molded polymeric material. The assembling of the torus and torus components is known in the art.

The torsional vibration assembly 100 is assembled by mounting the radially inner shafts 124 and the radially outer shafts 134 on one of the retainer plates 102 or 112. The radially inner roller bodies 126 and the radially inner roller bearings 128 are mounted on the radially inner shafts 124, and the radially outer roller bodies 136 and the radially outer roller bearings 138 are mounted on the radially outer shafts 134. The opposite ends of the radially inner and radially outer shafts 124 and 134 and mounted to the other of the retainer plates 102 and 112. The rivets 122 rotationally couple the retainer plates 102 to one another.

The locking piston 76 is rotationally coupled to the torsional vibration assembly 100 by inserting the axially extending tabs 82 of the locking piston 76 into sliding engagement with the notches 105 and 115. The engagement of the tabs 82 and notches 105 and 115 allows axial motion of the locking piston 76 with respect to the retainer plates 102 and 112, whereby the locking piston 76 is allowed to move axially into and out of lock-up mode by controlling the fluid pressures in the compartments 92 and 94. The second retainer plate 112 is rotationally coupled to and axially fixed to the radially inner end of the turbine shell 62 by welding at weld 68. The hydrodynamic torque converter 20 is mounted to the driven shaft 24 so that the splines 146 of the annular output hub 142 mesh with corresponding splines 24a of the driven shaft 24. The radially inner flange end 78 of the locking piston is slidingly mounted on the driven shaft 24.

The various components and features of the above-described exemplary embodiments may be substituted into one another in any combination. It is within the scope of the invention to make the modifications necessary or desirable to incorporate one or more components and features of any one embodiment into any other embodiment. In addition, although the exemplary embodiments discuss steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined, and/or adapted in various ways.

The foregoing description of the exemplary embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A torsional vibration damper, comprising:
a drive-side transmission element;
a driven-side transmission element; and
an energy-storage member rotatable relative to the drive-side transmission element and rotationally coupled to the driven-side transmission element, the energy-storage member comprising radially inner elastic blades and radially outer elastic blades positioned radially outward relative to the radially inner elastic blades, the drive-side transmission element being operatively associated with the energy-storage member to cause the radially inner elastic blades and the radially outer elastic blades to be displaced radially and elastically in response to relative rotation between the drive-side and driven-side transmission elements about a rotational axis of the torsional vibration damper.

2. The torsional vibration damper of claim 1, wherein the drive-side transmission element comprises at least one retainer plate, a plurality of radially inner bodies mounted to the retainer plate, and a plurality of radially outer bodies mounted to the retainer plate.

3. The torsional vibration damper of claim 1, wherein:
the drive-side transmission element comprises first and second retainer plates, a plurality of radially inner bodies mounted to and extending axially between the first and second retainer plates, and a plurality of radially outer bodies mounted to and extending between the first and second retainer plates.

4. The torsional vibration damper of claim 2, wherein the radially inner bodies are respectively operatively associated with the radially inner elastic blades, and wherein the radially outer bodies are respectively operatively associated with the radially outer elastic blades.

5. The torsional vibration damper of claim 2, wherein the radially inner bodies are angularly offset from the radially outer bodies.

6. The torsional vibration damper of claim 2, wherein the radially inner bodies comprise radially inner roller bodies, and wherein the radially outer bodies comprise radially outer roller bodies.

7. The torsional vibration damper of claim 6, further comprising:
a plurality of radially inner shafts;
a plurality of radially inner roller bearings adapted to permit rotation of the radially inner roller bodies about the radially inner shafts;
a plurality of radially outer shafts; and
a plurality of radially outer roller bearings adapted to permit rotation of the radially outer roller bodies about the radially outer shafts.

8. The torsional vibration damper of claim 1, wherein the radially inner elastic blades have radially inner convex raceways and the radially outer elastic blades have radially outer convex raceways.

9. The torsional vibration damper of claim 8, wherein:
the drive-side transmission element comprises radially inner bodies respectively operatively associated the radially inner convex raceways to move along the radially inner convex raceways in response to the relative rotation; and
the driven-side transmission element comprises radially outer bodies respectively operatively associated the radially outer convex raceways to move along the radially outer convex raceways in response to the relative rotation.

10. The torsional vibration damper of claim 1, wherein the driven-side transmission element comprises an output hub.

11. The torsional vibration damper of claim 1, wherein the energy-storage member comprises first and second radial arms diametrically opposed to one another, wherein said radially inner elastic blades comprise first and second radially inner elastic blades extending from the first and second radial arms, respectively, and wherein said radially outer elastic blades comprise first and second radially outer elastic blades extending from the first and second radial arms, respectively.

12. The torsional vibration damper of claim 1, wherein the driven-side transmission element is configured to directly and non-rotatably engage a transmission input shaft.

13. The torsional vibration damper of claim 1, wherein the energy-storage member is a one-piece integral body.

14. The torsional vibration damper of claim 1, wherein the torsional vibration damper is free of a coil spring.

15. A hydrodynamic torque converter, comprising:
a casing;
an impeller rotationally coupled to the casing;
a turbine hydrodynamically rotationally drivable by the impeller; and
the torsional vibration damper of claim 1 rotationally coupled to the casing, the turbine, or the casing and the turbine.

16. The hydrodynamic torque converter of claim 15, further comprising a stator operatively associated with the casing and the impeller to form a torus.

17. The hydrodynamic torque converter of claim 15, further comprising:
a lock-up clutch movable into and out of locking mode with the casing, wherein the lock-up clutch is rotationally coupled to the drive-side transmission element.

18. The hydrodynamic torque converter of claim 17, wherein the lock-up clutch comprises a locking piston axially movable relative to the drive-side transmission element.

19. The hydrodynamic torque converter of claim 15, wherein the turbine comprises a turbine shell rotationally coupled to the drive-side transmission element.

20. The hydrodynamic torque converter of claim 15, wherein the hydrodynamic torque converter is configured to connect an internal combustion engine crankshaft to a transmission input shaft.
